(19) United States
(12) Patent Application Publication
(10) Pub. No.: US 2024/0332927 A1
(43) Pub. Date: Oct. 3, 2024

(54) Armored Cable Cutter

(71) Applicant: Klein Tools, Inc., Lincolnshire, IL (US)

(72) Inventors: Brandon C. Deason, Fort Worth, TX (US); Andres Olivas, Waco, TX (US)

(73) Assignee: Klein Tools, Inc., Lincolnshire, IL (US)

(21) Appl. No.: 18/622,636

(22) Filed: Mar. 29, 2024

Related U.S. Application Data
(60) Provisional application No. 63/456,164, filed on Mar. 31, 2023.

(51) Int. Cl. H02G 1/12

(52) U.S. Cl. CPC H02G 1/1224

(57) ABSTRACT

An armored cable cutter is provided for cutting the armor of an armored cable and includes an upper grip housing, a lower grip housing, a folding crank handle assembly, and a cutting blade 22 mounted for rotation about a drive axis in response to a user operating the crank handle assemble. The crank handle assembly is mounted to the cable cutter so that it can be pivoted between a stored position, shown and an operating position. With the crank handle assembly in the stored position, the cable cutter has a reduced overall size and an improved form factor for storage and transport in comparison to the size and form factor of the cable cutter with the crank handle assembly in the operating position.

### CROSS-REFERENCE TO RELATED APPLICATIONS

This application claims priority to U.S. Provisional Patent Application Ser. No. 63/456,164, titled “Armored Cable Cutter, and filed Mar. 31, 2023, the entire contents of which are incorporated herein by reference.

### BACKGROUND OF THE DISCLOSURE

The present disclosure relates tools that cut the armor of armored cables, such as BX-cable and Metal Clad cable (MC-cable), to allow access to the insulated conductors protected by the armor. Many such tools are currently available and typically include a pair of grip/housing components that are connected to move relative to each other and to clamp an armored cable when the grip/housing components when a user's hand forces the grip/housing components together. The cutting of the armor is typically achieved via a wheel shaped cutting blade that is mounted in one of the grip/housing components and rotated via a crank handle that is also mounted in the same grip/housing component. The tools are commonly referred to as Armored Cable Cutters, BX Cable Cutters, and/or MC Cable cutters, some examples of which can be seen in U.S. Pat. Nos. 2,654,942; 3,851,387; 4,142,229; 4,359,819; 4,769,909; 7,891,097; 8,191,226; and 9,088,144. While such conventional armored cable cutters are suitable for their intended purpose, there is always room for improvement. For example, because of their shape and form factor, the storage and transport of such conventional cable cutters is less than optimal. As another example, a user can easily over compress or crush the armor in an undesirable fashion when operating some conventional cable cutters.

### BRIEF SUMMARY OF THE DISCLOSURE

In accordance with one feature of this disclosure, a cable cutter is provided for cutting the armor from an armored cable.

In one feature, the cable cutter includes a housing configured to receive an armored cable, a cutting blade mounted to the housing for rotation about a drive axis, and a user operated crank handle. The crank handle is mounted to the housing to pivot about a pivot axis between a stored position and an operating position and to rotate about a crank handle axis when the crank handle is in the operating position with the crank handle operably coupled to the cutting blade to rotate the cutting blade about the drive axis in response to a user rotating the crank handle about the crank handle axis. The cable cutter has a more compact form factor with the crank handle in the stored position than with the crank handle in the operating position.

According to one feature, the housing includes an upper housing and a lower housing. In a further feature, the upper housing is connected to the lower housing to pivot between a ready position and a cutting position.

As one feature, the upper and lower housings are grip housings configured to be grasped by the hand of a user.

In one feature, the crank handle and the cutting blade are mounted to the upper housing and the lower housing includes an elongate conduit guide channel extending along a longitudinal axis to receive a length of armored cable and locate the armored cable relative to the cutting blade.

According to one feature, the cable cutter further includes a drive shaft mounted in the housing to rotate about the drive axis, and wherein the cutting blade is carried on the drive shaft for rotation therewith about the drive axis. In a further feature, the crank handle is directly connected to the drive shaft.

As one feature, the crank handle is releasably retained in the stored position.

According to one feature, the crank handle includes a ridged, elongate torque transmission member having a central portion that is curved, the central portion positioned closely adjacent the housing with the handle in the stored position and spaced from the housing with the handle in the operating position. In a further feature, the crank handle further includes a round shaped grip member carried on the torque transmission member. In yet a further feature, the grip member is positioned adjacent an end of the housing with the handle in the stored position. In a related feature, the grip member does not extend past a side surface of the housing located on an opposite side of the housing from the handle with the handle in the stored position.

In one feature, the cutting blade is a disc shaped cutting blade.

In one feature, the cutter includes a housing configured to receive an armored cable, a cutting blade mounted to the housing for rotation about a drive axis, and a user operated crank handle. The crank handle is mounted to the housing to pivot about a pivot axis between a stored position and an operating position and to rotate about a crank handle axis when the crank handle is in the operating position with the crank handle operably coupled to the cutting blade to rotate the cutting blade about the drive axis in response to a user rotating the crank handle about the crank handle axis. A portion of the crank handle is positioned closely adjacent the housing with the handle in the stored position and is spaced from the housing with the handle in the operating position. In a further feature, the crank handle includes a ridged, elongate torque transmission member defining the portion of the crank handle.

It should be understood that the inventive concepts disclosed herein do not require each of the features discussed above, may include any combination of the features discussed, and may include features not specifically discussed above.

### BRIEF SUMMARY OF THE SEVERAL VIEWS OF THE DRAWINGS

FIG. 1 is a perspective view from the front, above, and right side of an armored cable cutter according to this disclosure showing a crank handle in a stored position;

FIG. 2 is a bottom view of the cable cutter of FIG. 1;

FIG. 3 is a front view of the cable cutter of FIGS. 1 and 2;

FIG. 4 is a back view of the cable cutter of FIGS. 1-3;

FIG. 5 is a section view taken generally from line 5-5 in FIG. 2;

FIG. 6 is a perspective view from the rear, above, and right side of the cable cutter of FIGS. 1-5;

FIG. 7 is an enlarged, partial bottom view of the cable cutter of FIGS. 1-6;

FIG. 8 is a view identical to FIG. 6 but showing the crank handle in a use/operating position;

FIG. 9 is a partial section view taken along line 9-9 in FIG. 8;

FIG. 10 is a section view shown in perspective and taken generally along line 10-10 in FIG. 2;

FIG. 11 is a section view taken along line 10-10 in FIG. 2.

FIG. 12 is a perspective view from the front and right side showing a portion of the cable cutter of FIGS. 1-11 with the crank handle in the stored position;

FIG. 13 is a right side view of the cable cutter of FIGS. 1-13 showing the crank handle in the use position and an upper grip body/housing in a ready position;

FIG. 14 is a view identical to FIG. 13 but showing the upper grip body/housing in a cutting position relative;

FIG. 15 is an enlarged perspective view from the right, above, and front showing a portion of the cable cutter, with a portion of the lower grip body/housing assembly being transparent for purposes of illustration;

FIG. 16 is an enlarge perspective view from the right, above and front of a 2-finger button component of the cable cutter of FIGS. 1-15;

FIG. 17 is an enlarged perspective view from the right, above and front of an alternate embodiment for a 2-finger button component for the cable cutter of FIGS. 1-16, incorporating an alternate cable locating/clamping component;

FIG. 18 is an enlarged perspective view from the right and front showing the alternate embodiments of FIG. 17 incorporated into the cable cutter of FIGS. 1-16;

FIG. 19 is a perspective view from the front, above, and left of the upper grip body/housing assembly of the cable cutter of FIGS. 1-18;

FIG. 20 is a perspective view from the front, above, and left of the lower grip body/housing assembly of the cable cutter of FIGS. 1-18;

FIG. 21 is a perspective view from the front, above, and right of the lower grip body/housing assembly of FIG. 20; and

FIG. 22 is a perspective view of the crank handle assembly and a drive shaft of the cable cutter of FIGS. 1-18, with the crank handle in the stored position relative to the drive shaft.

### DETAILED DESCRIPTION OF PREFERRED EMBODIMENTS

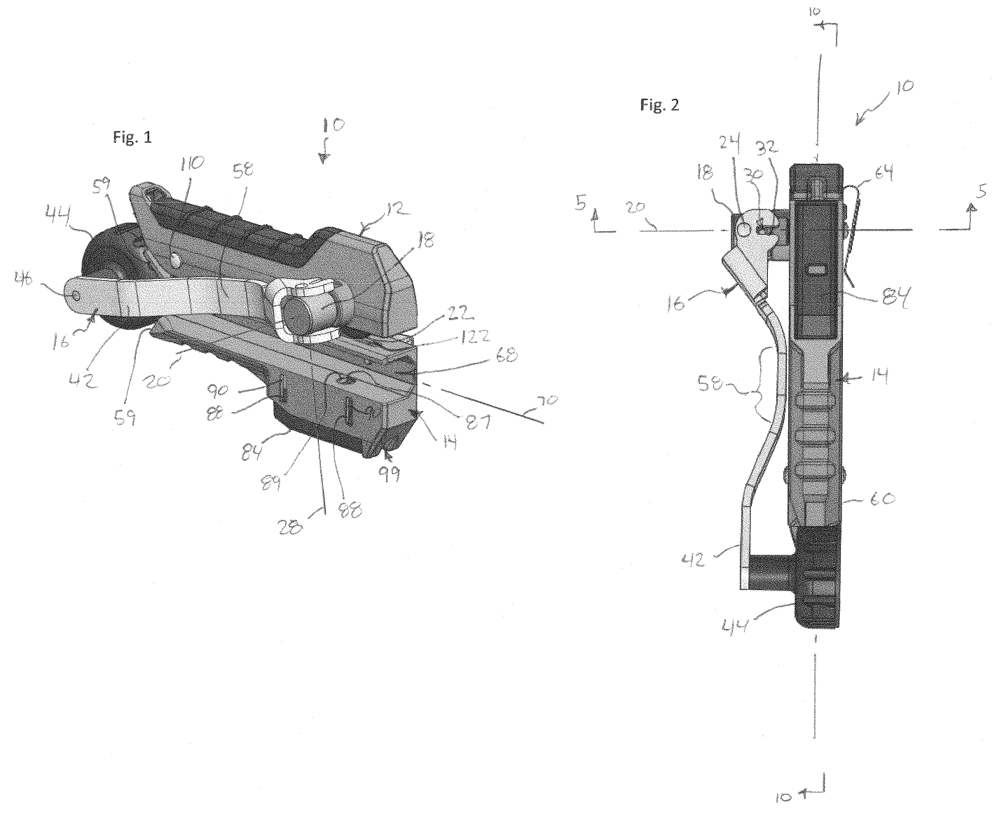

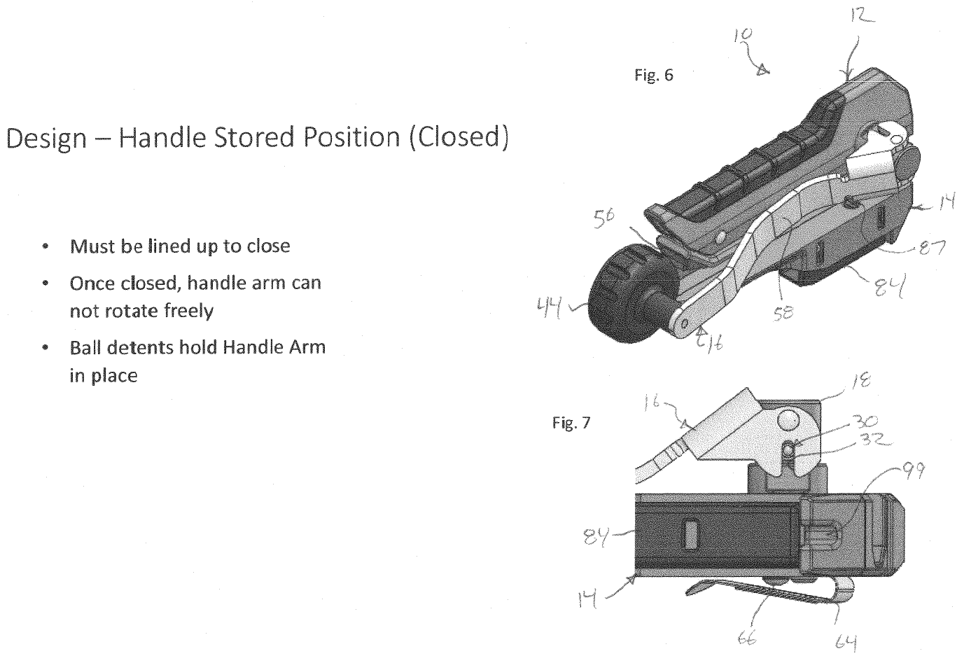

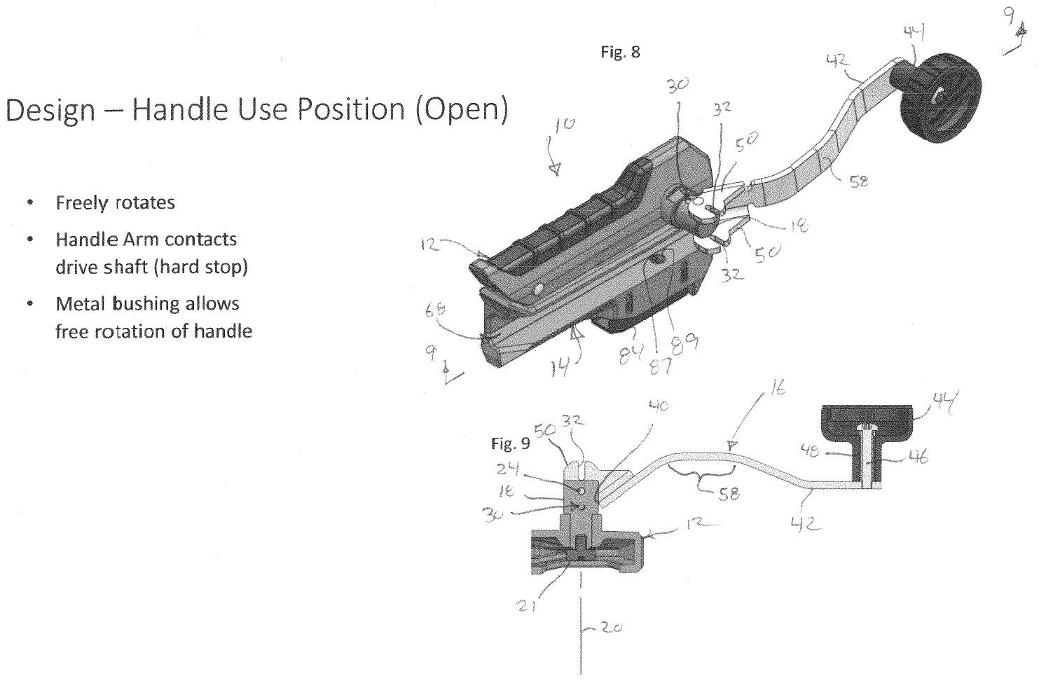

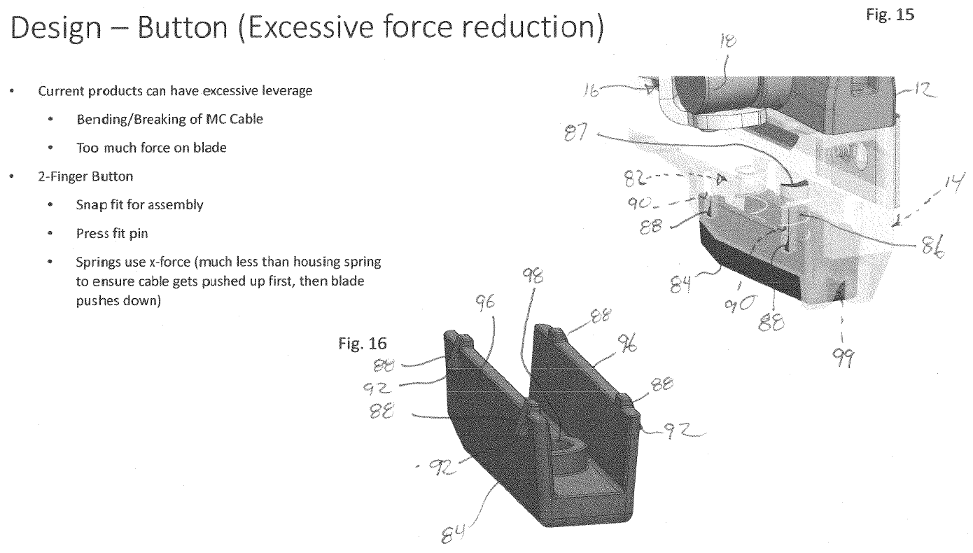

As best seen in FIGS. 1-9, an armored cable cutter 10 is provided for cutting the armor of an armored cable such as a BX Cable or an MC Cable. The cable cutter 10 includes an upper grip housing 12, a lower grip housing 14, a folding crank handle assembly 16, a drive shaft 18 rotatable about a drive axis 20, and a disc shaped cutting blade 22 fixed to the drive shaft 18 for rotation about the drive axis 20 in response to a user operating the crank handle assembly 16. The crank handle assembly 16 is mounted to the cable cutter 10 so that it can be pivoted between a stored position, shown in FIGS. 1-7, 10-12, and 15, and a use or operating position, shown in FIGS. 8, 9, 13, and 14. With the crank handle assembly 16 in the stored position, the cable cutter 10 has a reduced overall size and a greatly improved form factor for storage and transport in comparison to the size and form factor of the cable cutter 10 with the handle assembly 16 in the use position and in comparison to currently available armored cable cutters.

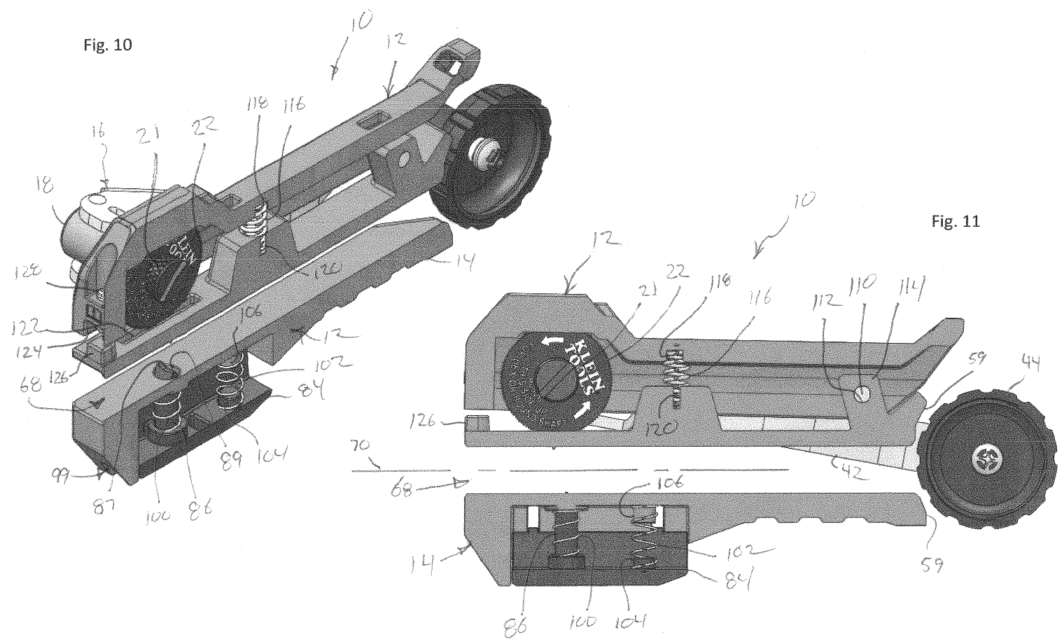

‘In the illustrated and preferred embodiment, the crank handle assembly 16 is directly connected to the drive shaft 18 and the drive shaft 18 is mounted in the upper grip housing 12 to rotate about the drive axis 20. The disc shaped cutting blade 22 is carried on the drive shaft 18 for rotation therewith about the axis 20 in response to a user rotating the crank handle assembly 16 about the axis 20 with the crank handle assembly 16 in the use position. As best seen in FIGS. 5 and 10, the cutting blade 22 is fixed to the drive shaft 18 using a threaded fastener 21 in the form of a thumb screw having a knurled head with a slot for a flat bladed screw driver.

As best seen in FIG. 5, a rivet pin 24 is fixed to the crank handle assembly 16 and extends through a journal bore 26 formed in the drive shaft 18 to rotate in the bore 26 about a pivot axis 28 as the crank handle assembly 16 pivots about the axis 28 between the stored and use position. The crank handle assembly 16 and rivet pin 24 are secured together via deformation of the heads of the rivet pin 24. It should be appreciated that while the illustrated rivet pin 24 and bore 26 are preferred, there are many other known types of pivot connections that could be used to connect the crank handle assembly 16 to the drive shaft 18 for use in the cable cutter 10 according to this disclosure. For example, a hardened pin could be press-fit into the drive shaft 18 with the crank handle assembly being pivot mounted onto opposite ends of the hardened pin that extend outwardly from the drive shaft 18. The drive shaft is rotatably received in a journal bore 27 formed in the upper grip housing 12 centered on the axis 28. In some cases, it may be desirable to fix a journal sleeve in the bore 27 to provide optimum rotation of the shaft 18 relative to the upper grip housing 12 and/or to minimize wear between the shaft 18 and the upper grip housing 12.

In the illustrated and preferred embodiment, the crank handle assembly 16 is releasably retained in the stored position by a pair of oppositely directed ball detents 30 mounted carried in the drive shaft 18 and configured to extend into respective receiving reliefs or slots 32 formed in the crank handle assembly 16. Each of the ball detents 30 include a ball 34 that is biased radially outwardly by a helical compression spring 36. It should be appreciated that while the illustrated ball detents 30 are preferred, other types of known detents may be desirable and can be employed in the cable cutter 10 to releasably retain the crank handle assembly 16 in the stored position according to this disclosure, including detents employed in locations other than between the drive shaft 18 and the crank handle assembly 16. Additionally, it should be appreciated that in some applications, it may be desirable to not utilize any type of detent.

As best seen in FIG. 9, a stop surface 40 formed on the crank handle assembly 16 engages against an outer surface of the drive shaft 18 to locate the crank handle assembly 16 in the use position and to restrict further pivoting of the crank handle assembly 16 about the axis 28 beyond the use position.

In the illustrated and preferred embodiment, the crank handle assembly 16 includes a ridged, elongate, torque transmission member 42 and a round shaped grip member 44 that is mounted to the torque transmission member 42 by a threaded fastener 46 that extends through a cylindrical journal sleeve 48 to engage a threaded bore formed in the torque transmission member 42. In the illustrated and preferred embodiment, the torque transmission member 42 is formed from a single piece of material and includes a spaced pair of shaft engagement wings 50, with each wing 50 defining one of the slots 32 and a bore 56 that receives a corresponding end portion of the rivet pin 24. As best seen in FIG. 2, the torque transmission member 42 has a central portion 58 that is curved inwardly so that it lays closely adjacent to the grip housings 12 and 14 with the crank handle assembly 16 in the stored position. This shape helps to minimize the size and form factor of the cutter 10 with the crank handle assembly in the stored position, and allows a user's hand to simultaneously grasp the torque transmission member 44 and the grip housings 12 and 14 with the crank handle assembly 16 in the stored position. Additionally, as best seen in FIGS. 8 and 9, this shape reduces the likelihood that the torque transmission member 44 will engage a user's hand that is grasping the grip housings 12 and 14 while the user's other hand is rotating the crank housing assembly 16 about the axis 20 to cut an armored cable engaged in the lower grip housing 14.

As best seen in FIGS. 1 and 11, in the illustrated and preferred embodiment, the lower grip housing 14 includes a pair of stop surfaces that can engage the grip member 44 of the crank handle assembly 16 to limit the rotation of the crank handle assembly 16 about the axis 20 with the crank handle assembly 16 in the stored position. As best seen in FIG. 4, in the illustrated and preferred embodiment, the crank handle assembly 16 is configured so that the grip member 44 does not extend past the left side lateral surface 60 of the lower grip housing 14 and the surface 60 of the lower grip housing 14 lies in the same plane as the left side lateral surface 62 of the upper grip housing 12. This again helps to define a form factor for the cable cutter 10 that is convenient for storage and transport, such as for sliding the cable cutter 10 into the pocket of a soft sided tool bag or the pocket of an article of clothing worn by the user. In this regard, the illustrated and preferred embodiment has been provided with an optional belt/pocket clip 64 that is removably mounted on the surface 60 of the lower grip housing 14 using a threaded fastener 66 that engages a threaded bore in the lower grip housing 14.

In the illustrated and preferred embodiment, the lower grip housing 14 includes an elongate conduit guide channel 68 extending along a longitudinal axis 70, with the longitudinal axis 70 being perpendicular to the drive axis 20. The channel has a U-shaped cross section defined by a lower planar surface 72, an upper planar surface 74, a side planar surface 76, an angled planar surface 78 extending between the lower planar surface 72 and the side planar surface 76, and an angled planar surface 80 extending between the upper planar surface 74 and the side planar surface 76, with all the planar surfaces 72-80 extending parallel to the longitudinal axis 70. The purpose of the conduit channel 68 is to receive a length of armored cable and to locate the armored cable relative to the cutting blade 22 as the cutting blade 22 cuts through the armor of the armored cable. It should be appreciated that while the preferred shape and configuration for the channel 68 has been shown in the FIGS., in some applications other configuration may be desirable and can be employed in the cable cutter 10 according to this disclosure.

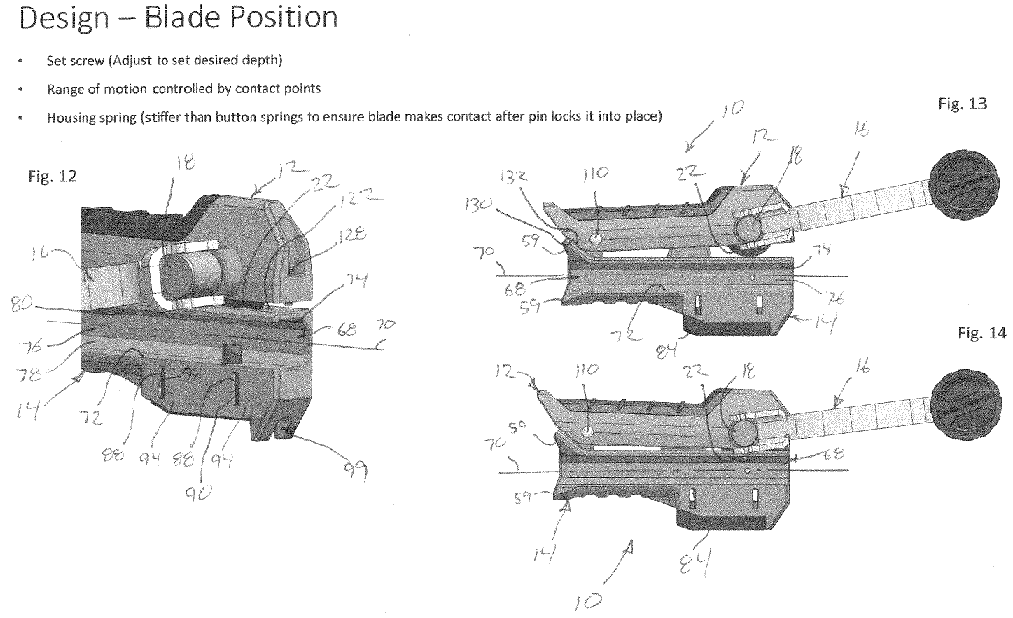

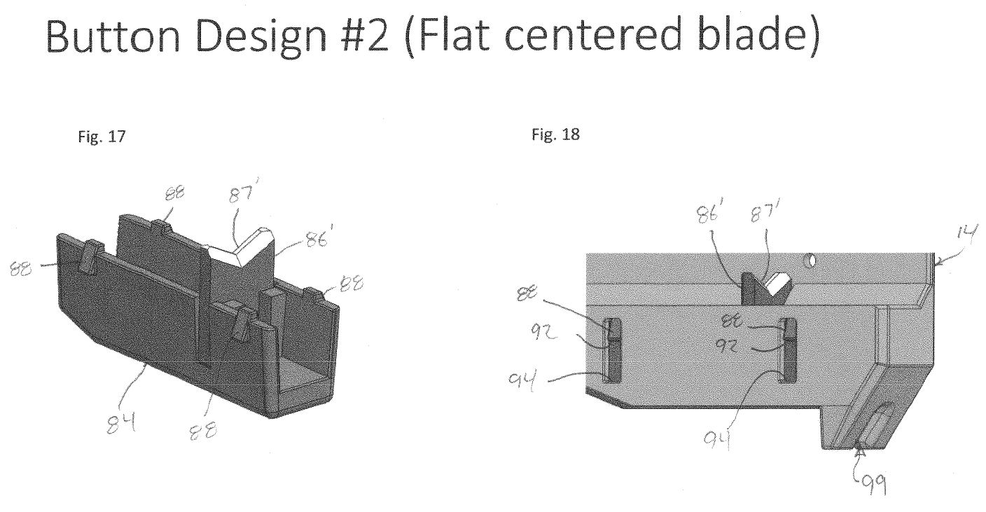

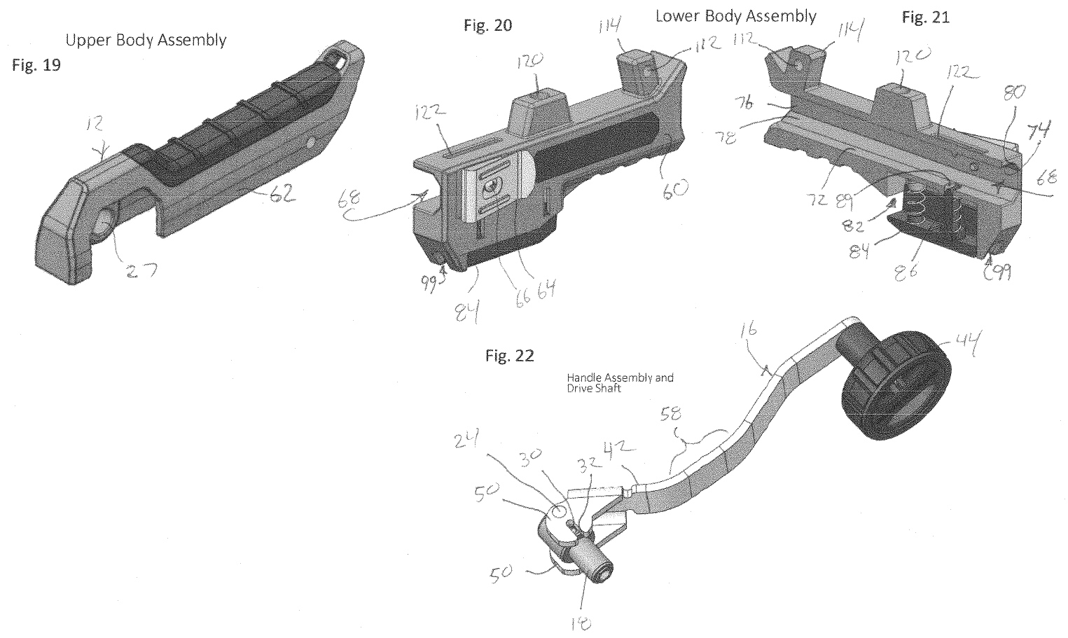

In the illustrated and preferred embodiment, the lower grip housing 14 further includes a downwardly opening recess 82 that receives a finger actuated button 84 that is mounted in the recess 82 to translate relative to the lower grip housing 14 from a ready position shown in FIGS. 1, 3, 5, 10, 11, and 15 to a locating/clamping position shown in FIG. 12 in response to pressure applied by a user's finger or fingers. A cylindrical shaped, conduit locating/clamping pin 86 is fixed to the button 84 to translate therewith, with the pin 86 having concave, arcuate shaped, conduit engaging surface 87 to engage the outer surface of the armor on an armored cable. It should be understood that many conventional armored cable cutters utilize a locating/clamping pin similar to the pin 86 and that the use of any of the conventional pins may be desirable in some applications of the cable cutter 10 according to this disclosure. A guide opening 89 is provided in the lower grip housing to allow the pin 86 to extend into the channel 68. For example, FIGS. 17 and 18 illustrate an alternate embodiment for the pin 86 wherein the pin 86 is provided in the form of a flat blade 86’ that is press fit into a receiving slot formed in the button 84 and having a V-shaped conduit engaging surface 87′.

In the illustrated and preferred embodiment, the button 84 and pin 86 are configured to translate perpendicular to the longitudinal axis 70 between the ready and the locating/clamping positions. In this regard, in the illustrated and preferred embodiment, the button 84 includes four tabs 88, with each tab 88 received in a corresponding linear guide slot 90 extending in the lower grip housing perpendicular to the axis 70. Each of the tabs 88 has a ramp shape that allows for snap fit assembly of the button 84 to the lower grip housing 14, with respective stop surfaces 92 and 94 of the tabs 88 and the slots 90 engaging each other to retain the button 84 in the lower grip housing 14 and to limit downward movement of the button 84 relative to the housing 14. In the illustrated and preferred embodiments, the tabs 82 are formed on side walls 96 of the button 84 and the recess 82 is shaped and sized to closely conform to the side walls 96 to aid in guiding and supporting the button 84. The pin 86 is press fit into a receiving bore 98 formed in the button 84. In the illustrated and preferred embodiment, the lower grip housing includes a cleaning opening 99 to allow material debris created by the cutting process to be easily removed from the button 84, such as by blowing air through the opening 99 toward the opposite open end of the button 84.

In the illustrated and preferred embodiment, the button 84 is biased away (downwardly) from the lower grip housing 14, preferably by a pair of helical compression springs 100 and 102, with opposite ends of each of the springs 100 and 102 abutted against the button 84 and the lower grip housing 14. The spring 100 is sized to extend around the pin 86. The spring 102 is sized to extend around respective locating posts 104 and 106 formed on the button 84 and the lower grip housing 14. While the two helical compression springs are preferred, it should be understood that a single spring or more than two springs, each of any suitable construction/configuration could be employed in the cable cutter 10 according to this disclosure. The button 84 is preferably sized to be engaged by two fingers (ideally the forefinger and the middle finger) of a user's hand as the user grasps the upper and lower grip housings 12 and 14.

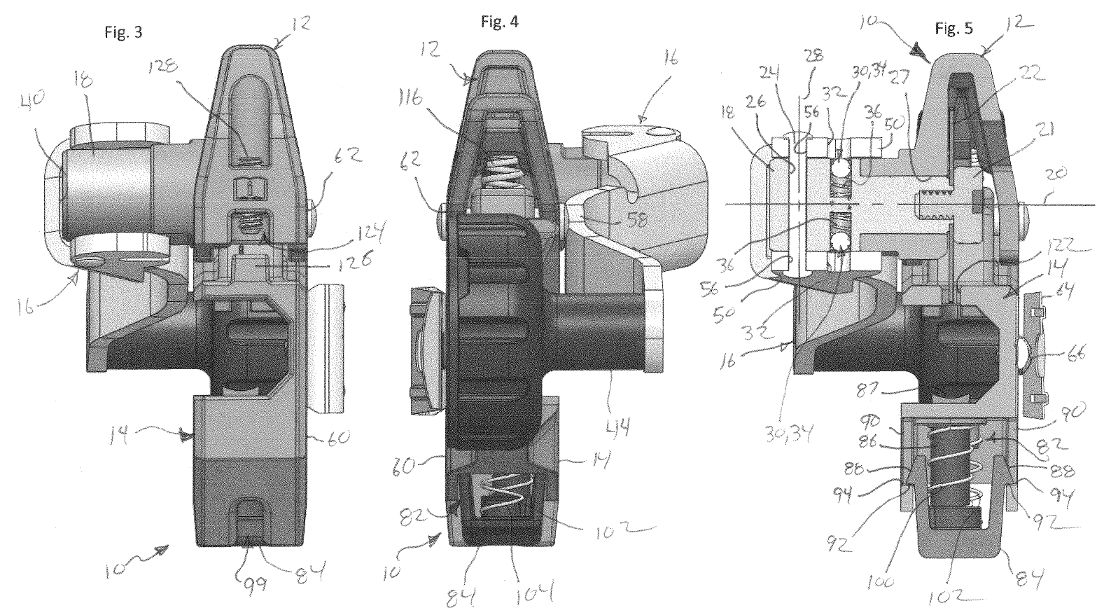

The upper grip housing 12 is connected to the lower grip housing 14 to pivot between a ready position shown in FIGS. 1, 3, 10, and 11-13 and a cutting position shown in FIG. 14. In this regard, a pivot pin 110 is fixed to the upper housing and extends perpendicular to the longitudinal axis 70 through a journal bore 112 formed in a mount boss 114 of the lower grip housing 14. It should be understood that other types of pivot configurations, many of which are known, could be employed in the cable cutter 10 according to this disclosure. In the illustrated and preferred embodiment, the upper grip housing is biased toward the ready position, with the bias force being supplied by a helical compression spring 116 having opposite ends engaged against the upper grip housing 12 and the lower grip housing 14. One end of the spring 116 is received in a bore 118 formed in the upper grip housing 12 and the other end of the spring 116 is received in a bore 120 formed in the lower grip housing 14. While the spring 116 is preferred, it should be understood that other types and configurations can be used in the cable cutter 10 according to this disclosure. The lower grip housing 14 includes an elongate blade slot 122 extending parallel to the axis 70 to allow the blade 22 to extend into the conduit guide channel 68 as the upper grip housing moves from the ready position to the cutting position. In the illustrated and preferred embodiment shown in FIGS. 3, 9, and 10, the upper grip housing 12 includes a guide slot 124 that closely conforms to a guide post 126 on the lower grip housing 14 to maintain proper alignment of the housings 12 and 14 during a cutting operation with the upper grip housing 12 in the cutting position.

As best seen in FIGS. 10, in the illustrated and preferred embodiments, a threaded set screw 128 is provided in a threaded bore of the upper grip housing to provide a precision adjustment of the cutting depth of the blade 22 into the armor of an armored cable during the cutting operation with the upper grip housing in the cutting position. To state this in other terms, the bottom of the set screw 128 engages a surface on the lower grip housing to define the location of the upper grip housing 12 and the blade 22 relative to the lower grip housing 14 and an armored conduit clamped in the guide channel 68 with the upper grip housing in the cutting position. As best seen in FIG. 30, a pair of stop surfaces 130 and 132 on the upper and lower grip housings 12 and 14, respectively, abut each other to define the location of the upper grip housing 12 relative to the lower grip housing 14 with the upper grip housing in the ready position, as best seen in FIG. 13.

In the illustrated and preferred embodiments, the spring rates of the springs 100, 102, and 116 are selected to insure that the force required to actuate the button 84 from the ready position to the locating/clamping position is less than the force required to pivot the upper grip housing 12 from the ready position to the cutting position. The helps to insure that an armored cable received in the guide channel 68 is located and clamped in cutter 10 before the blade 22 engages the armor of the armored cable during a cutting operation. It is believed that the finger actuated linear movement of the button 84 provides a superior location and clamping of an armored cable in the cutter 10 in comparison to many more conventional armored cable cutters 10 that incorporate a pivoted lever to actuate a locating/clamping pin against an armored cable.

Preferably, each of the components 12, 14, 18, 42, 44 and 84 are formed from a suitable structural material, such a suitable metal, plastic, or composite material, as will be easily understood by one skilled in the art.

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the armored cable cutter 10 are shown in the figures, it should be understood that this disclosure anticipates variations in the specific details of each of the disclosed components and features of the armored cable cutter 10 and that no limitation to a specific form, configuration, or detail is intended unless expressly and specifically recited in an appended claim.

For example, while specific and preferred forms have been shown for the grip housing 12 and 14, drive shaft 18, blade 22, button 84 and pin 86, the folding feature for the crank handle assembly 16 can be advantageously employed with other configurations for each of those components and can be employed with many conventional armored cable cutters. As another example, while the shape and configuration of the crank handle assembly 16 is preferred, many other shapes and configurations of the crank handle assembly 16 could be employed with the other features disclosed herein, including with the folding handle feature disclosed herein. For example, the grip member could be a different shape and/or could be formed as a unitary part of the ridged, elongate, torque transmission member 42, with both members 42 and 44 formed from a single piece of material. As yet another example, non-folding handles could be used in the cutter 10 for use with the finger actuated button 84 as disclosed herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “upper”, “lower”, “upwardly” and “downwardly” are used for convenience of description relative to the orientation of the components in the figures and should not be construed as requiring a particular orientation of the component relative to a user of the cable cutter 10. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

All references, including publications, patent applications, and patents, cited herein are hereby incorporated by reference to the same extent as if each reference were individually and specifically indicated to be incorporated by reference and were set forth in its entirety herein.

What is claimed is:

1. A cable cutter for cutting the armor from an armored cable, the cutter comprising:
a housing configured to receive an armored cable;
a cutting blade mounted to the housing for rotation about a drive axis; and
a user operated crank handle mounted to the housing to:
a. pivot about a pivot axis between a stored position and an operating position, and
b. rotate about a crank handle axis when the crank handle is in the operating position with the crank handle operably coupled to the cutting blade to rotate the cutting blade about the drive axis in response to a user rotating the crank handle about the crank handle axis;
wherein cable cutter has a more compact form factor with the crank handle in the stored position than with the crank handle in the operating position.

2. The cable cutter of claim 1 wherein the housing comprises an upper housing and a lower housing.

3. The cable cutter of claim 2 wherein the upper housing is connected to the lower housing to pivot between a ready position and a cutting position.

4. The cable cutter of claim 1 wherein the upper and lower housings are grip housings configured to be grasped by the hand of a user.

5. The cable cutter of claim 2 wherein the crank handle and the cutting blade are mounted to the upper housing and the lower housing comprises an elongate conduit guide channel extending along a longitudinal axis to receive a length of armored cable and locate the armored cable relative to the cutting blade.

6. The cable cutter of claim 1 further comprising a drive shaft mounted in the housing to rotate about the drive axis, and wherein the cutting blade is carried on the drive shaft for rotation therewith about the drive axis.

7. The cable cutter of claim 6 wherein the crank handle is directly connected to the drive shaft.

8. The cable cutter of claim 1 wherein the crank handle is releasably retained in the stored position.

9. The cable cutter of claim 1 wherein the crank handle comprises a ridged, elongate torque transmission member having a central portion that is curved, the central portion positioned closely adjacent the housing with the handle in the stored position and spaced from the housing with the handle in the operating position.

10. The cable cutter of claim 9 where the crank handle further comprises a round shaped grip member carried on the torque transmission member.

11. The cable cutter of claim 10 wherein the grip member is positioned adjacent an end of the housing with the handle in the stored position.

12. The cable cutter of claim 11 wherein the grip member does not extend past a side surface of the housing located on an opposite side of the housing from the handle with the handle in the stored position.

13. The cable cutter of claim 1 wherein the cutting blade is a disc shaped cutting blade.

14. A cable cutter for cutting the armor from an armored cable, the cutter comprising:
a housing configured to receive an armored cable;
a cutting blade mounted to the housing for rotation about a drive axis; and
a user operated crank handle mounted to the housing to:
c. pivot about a pivot axis between a stored position and an operating position, and
d. rotate about a crank handle axis when the crank handle is in the operating position with the crank handle operably coupled to the cutting blade to rotate the cutting blade about the drive axis in response to a user rotating the crank handle about the crank handle axis;
wherein a portion of the crank handle is positioned closely adjacent the housing with the handle in the stored position and is spaced from the housing with the handle in the operating position.

15. The cable cutter of claim 14 wherein the housing comprises an upper housing and a lower housing.

16. The cable cutter of claim 15 wherein the upper housing is connected to the lower housing to pivot between a ready position and a cutting position.

17. The cable cutter of claim 15 wherein the crank handle and the cutting blade are mounted to the upper housing and the lower housing comprises an elongate conduit guide channel extending along a longitudinal axis to receive a length of armored cable and locate the armored cable relative to the cutting blade.

18. The cable cutter of claim 14 further comprising a drive shaft mounted in the housing to rotate about the drive axis, and wherein the cutting blade 22 is carried on the drive shaft for rotation therewith about the drive axis and the crank handle is directly connected to the drive shaft.

19. The cable cutter of claim 14 wherein the crank handle is releasably retained in the stored position.

20. The cable cutter of claim 14 wherein the crank handle comprises a ridged, elongate torque transmission member defining the portion of the crank handle.
